(19) United States
(12) Patent Application Publication
(10) Pub. No.: US 2021/0256618 A1
(43) Pub. Date: Aug. 19, 2021

(54) CONTROL METHOD OF INSURANCE SWITCHING DEVICE AND INSURANCE SWITCHING SYSTEM

(71) Applicant: Panasonic Intellectual Property Management Co., Ltd., Osaka (JP)

(72) Inventors: Kazunori INOUE, TOKYO TO (JP); Toshihiko MORI, KANAGAWA KEN (JP)

(73) Assignee: Panasonic Intellectual Property Management Co., Ltd., Osaka (JP)

(21) Appl. No.: 17/159,802

(22) Filed: Jan. 27, 2021

(30) Foreign Application Priority Data
Feb. 14, 2020 (JP) 2020-023852

(51) Int. Cl. G06Q 40/08; G06Q 50/30; G07C 5/00

(52) U.S. Cl. CPC G06Q 40/08; G07C 5/008; G06Q 50/30

(57) ABSTRACT

A control method of an insurance switching device in an embodiment is a control method of an insurance switching device including an input circuit and an output circuit. The control method of an insurance switching device in the embodiment includes: receiving, by the input circuit, input of duty information indicating a duty status of a user of a vehicle; receiving, by the input circuit, input of use information about a use situation of the vehicle; and outputting, by the output circuit, information indicating car insurance applied to the vehicle in accordance with the duty status of the user when the use information input into the input circuit indicates that the vehicle is in use.

### CROSS-REFERENCE TO RELATED APPLICATIONS

This application is based upon and claims the benefit of priority from Japanese Patent Application No. 2020-023852, filed on Feb. 14, 2020, the entire contents of which are incorporated herein by reference.

### FIELD

Embodiments described herein relate generally to a control method of an insurance switching device and an insurance switching system.

### BACKGROUND

When a plurality of pieces of car insurance having different contract contents are applicable to a single vehicle, techniques for switching car insurance applied to the vehicle by driver's manual operation have been disclosed. An example of the conventional techniques is Japanese Patent Application Laid-open No. 2007-058356.

When a person who is not the owner of a vehicle drives the vehicle, such techniques make it possible to apply car insurance different from the car insurance applied when the owner drives the vehicle by manually switching to the applicable car insurance.

The conventional techniques do not enable automatic switching of the car insurance applied to a vehicle in accordance with a duty status of the user of the vehicle.

### SUMMARY

A control method of an insurance switching device in an embodiment is a control method of an insurance switching device including an input circuit and an output circuit. The control method of an insurance switching device in the embodiment includes: receiving, by the input circuit, input of duty information indicating a duty status of a user of a vehicle; receiving, by the input circuit, input of use information about a use situation of the vehicle; and outputting, by the output circuit, information indicating car insurance applied to the vehicle in accordance with the duty status of the user when the use information input into the input circuit indicates that the vehicle is in use.

### BRIEF DESCRIPTION OF THE DRAWINGS

FIG. 1 is a diagram illustrating an example of a whole structure of an insurance switching system according to a first embodiment;

FIG. 2 is a diagram illustrating an example of a hardware structure of an on-board device according to the first embodiment;

FIG. 3 is a diagram illustrating an example of a hardware structure of an insurance switching device according to the first embodiment;

FIG. 4 is a diagram illustrating an example of functions of the insurance switching device and the on-board device according to the first embodiment;

FIG. 5 is a diagram illustrating an example of insurance switching information according to the first embodiment;

FIG. 6 is a diagram illustrating an example of duty information according to the first embodiment;

FIG. 7 is a sequence diagram illustrating an example of a flow of insurance switching processing according to the first embodiment;

FIG. 8 is a flowchart illustrating an example of a flow of insurance selection processing according to the first embodiment;

FIG. 9 is a diagram illustrating an example of a whole structure of the insurance switching system according to a second embodiment;

FIG. 10 is a diagram illustrating an example of functions of an on-board device according to the second embodiment;

FIG. 11 is a diagram illustrating an example of an alert displayed on a display according to the second embodiment;

FIG. 12 is a diagram illustrating an example of an installation position of the display according to the second embodiment;

FIG. 13 is a sequence diagram illustrating an example of a flow of the insurance switching processing according to the second embodiment;

FIG. 14 is a flowchart illustrating an example of a flow of determination processing of determining whether the alert needs to be output according to the second embodiment:

FIG. 15 is a diagram illustrating an example of functions of an insurance switching device according to a third embodiment; and

FIG. 16 is a diagram illustrating an example of the alert displayed on the display according to the third embodiment.

### DETAILED DESCRIPTION

The following describes embodiments of a control method of an insurance switching device and an insurance switching system according to the disclosure with reference to the accompanying drawings.

### First Embodiment

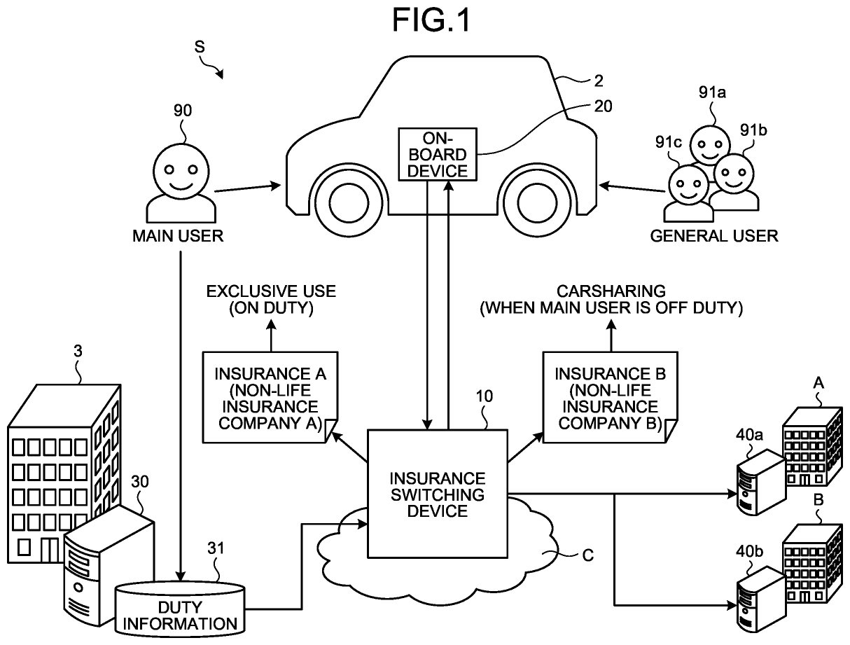

FIG. 1 is a diagram illustrating an example of a whole structure of an insurance switching system S according to a first embodiment. The insurance switching system S includes an on-board device 20 and an insurance switching device 10.

The on-board device 20 is a computer that can be mounted on a vehicle 2 and can communicate with the insurance switching device 10 via, for example, a network.

A main user 90 illustrated in FIG. 1 is a user who mainly uses the vehicle 2. The main user 90 is an employee of a company 3 owning the vehicle 2 as a commercial car. Hereinafter, when simply referred to as “the user of the vehicle 2,” the user is the main user 90.

General users 91a to 91c are users who use the vehicle 2 besides the main user 90. The general users 91a to 91c are users who use the vehicle 2 with carsharing when the main user 90 is off duty, for example. The number of general users, such as the general users 91a to 91c, is not limited to that exemplarily illustrated in FIG. 1. Hereinafter, the general users 91a to 91c are simply described as the general user 91 when they do not need to be differentiated from one another. In the first embodiment, whether the main user 90 is on duty or off duty is referred to as a “duty status” of the main user 90.

The vehicle 2 is mainly used by the main user 90, but the vehicle 2 can be used by the general user 91 when the main user 90 does not use the vehicle 2.

For example, the vehicle 2 is a commercial car of the company 3 for which the main user 90 works, and the vehicle 2 is exclusively used by the main user 90 when the main user 90 is on duty, for example, during the daytime on weekdays. When the main user 90 is on duty, the general user 91 other than the main user 90 does not use the vehicle 2.

When the main user 90 is off duty, for example, at night or weekend, the vehicle 2 can be used by the general user 91 as a carsharing vehicle. When the main user 90 is off duty, the main user 90 can use the vehicle 2 on the basis of a carsharing contract. In this case, the main user 90 uses the vehicle 2 as the general user 91.

The vehicle 2 is covered by a plurality of different pieces of car insurances according to use situations of the vehicle 2. In the first embodiment, the car insurance is simply referred to as the insurance. In the example illustrated in FIG. 1, when the vehicle 2 is exclusively used by the main user 90 when the main user 90 is on duty, “insurance A” of a non-life insurance company A is applied. When the vehicle 2 is exclusively used by the general user 91 when the main user 90 is off duty, “insurance B” of a non-life insurance company B is applied. In FIG. 1, the insurance A and the insurance B are provided respectively by different non-life insurance companies. The insurance A and the insurance B may be provided by the same non-life insurance company.

When the vehicle 2 is used, the insurance switching device 10 selects the insurance applied to the vehicle 2 in accordance with the duty status of the main user 90, and transmits the selected insurance to a server 40a of the non-life insurance company A or a server 40b of the non-life insurance company B. Hereinafter, the servers 40a and 40b are simply described as the server 40 when they do not need to be particularly differentiated from each other.

As illustrated in FIG. 1, the insurance switching device 10 acquires duty information 31 from a server 30 of the company 3 for which the main user 90 works. The server 30 is an example of a further information processing device.

The duty information 31 indicates the duty status of the main user 90. For example, in the duty information 31, identification information about the main user 90, an attendance time of the main user 90, and a quitting time of the main user 90 are associated with one another. The duty information 31 is described later in detail.

In the first embodiment, the insurance switching device 10 is a server provided in a cloud environment C. The insurance switching device 10 is managed by a business operator that provides service to switch insurances applied to the vehicle 2, for example. An example of the business operator is a company that provides a carsharing service. The business operator is, however, not limited to this example. The insurance switching device 10 may be managed by a non-life insurance company or the company 3 for which the main user 90 works. The environment in which the insurance switching device 10 is provided is not limited to the cloud environment C. Any environment that has the Internet access may be employed. For example, the insurance switching device 10 may be installed in the company that provides a carsharing service.

FIG. 1 illustrates an example in which the insurance switching device 10 switches the pieces of insurance of the vehicle 2. The insurance switching device 10 may perform switching of pieces of insurance on a plurality of vehicles 2. The multiple vehicles 2 may be commercial cars of different companies or private cars owned by individuals.

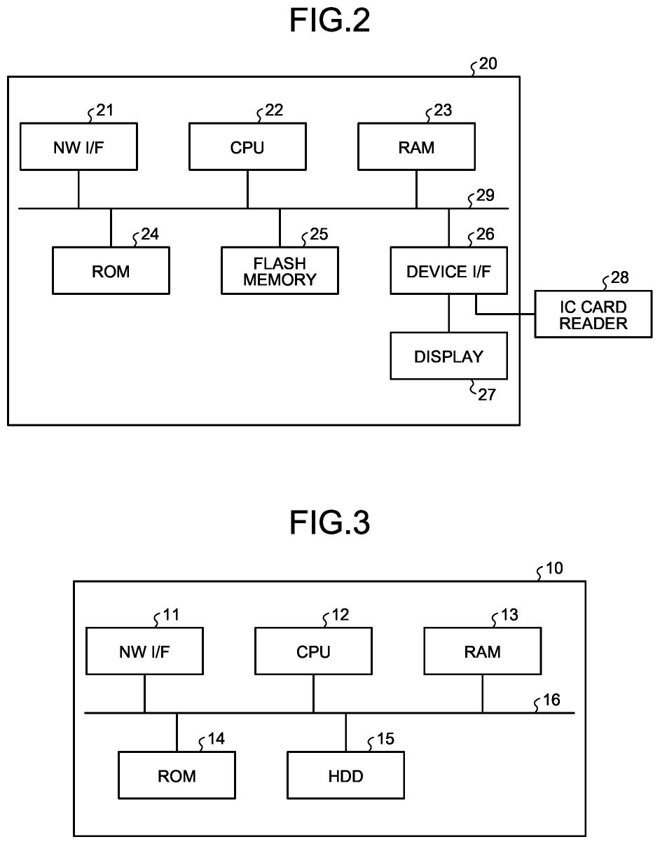

The following describes a hardware structure of the on-board device 20. FIG. 2 is a diagram illustrating an example of the hardware structure of the on-board device 20 according to the first embodiment. As illustrated in FIG. 2, the on-board device 20 includes a network interface (NW I/F) 21, a central processing unit (CPU) 22, a random access memory (RAM) 23, a read only memory (ROM) 24, a flash memory 25, a device interface (I/F) 26, and a display 27. The NW I/F 21, the CPU 22, the RAM 23, the ROM 24, the flash memory 25, and the device I/F 26 are connected to one another by a bus 29.

The NW I/F 21 can be connected to a network such as the Internet. The NW I/F 21 interchanges various types of information with the insurance switching device 10 via the network. The NW I/F 21 is an example of the second input circuit.

The CPU 22 executes a program stored in the ROM 24 or the flash memory 25 to perform various types of processing. The flash memory 25 is an example of a storage device of the on-board device 20. The on-board device 20 may include another storage device instead of or in addition to the flash memory 25.

The device I/F 26 can be connected to the display 27 and an integrated circuit (IC) card reader 28. The device I/F 26 is an example of the second output circuit. The device I/F 26 may be further capable of being connected to other devices. The device I/F 26 may be called a third input circuit.

The IC card reader 28 can read a non-contact IC card, for example. More specifically, when a service user starts using the vehicle 2 in the carsharing service, the IC card reader 28 reads the IC card held by the user to perform authentication of the user. Information read by the IC card reader 28 is sent out to the CPU 22 via the device I/F 26. In the first embodiment, the IC card reader 28 is not included in the on-board device 20. The IC card reader 28 may be included in the on-board device 20. When the vehicle 2 is not used with the carsharing, the vehicle 2 may not be provided with the IC card reader 28.

The display 27 is a liquid crystal display, for example, and is an example of the display unit. In the first embodiment, the display 27 is included in the on-board device 20. The display 27 may be provided without being included in the on-board device 20. For example, the display 27 may be installed on a rear side of the vehicle 2 in such a manner to face outside the vehicle 2. For another example, the display 27 may be a navigation screen provided at the center of an instrument panel (not illustrated) of the vehicle 2. The number of displays 27 is not limited to a specific number. The vehicle 2 may be provided with a plurality of displays 27.

The on-board device 20 is an electronic control unit (ECU) or an on-board unit (OBU) which is provided inside the vehicle 2, for example. Alternatively, the on-board device 20 may be an external device installed near a dashboard of the vehicle 2.

An example of the on-board device 20 may be a mobile terminal such as a smartphone. When such a structure is employed, the mobile terminal acquires information about whether the engine of the vehicle 2 operates, for example, from the ECU mounted on the vehicle 2 via a wireless network, for example.

The following describes a hardware structure of the insurance switching device 10. FIG. 3 is a diagram illustrating an example of the hardware structure of the insurance switching device 10 according to the first embodiment. As illustrated in FIG. 3, the insurance switching device 10 includes a network interface (NW I/F) 11, a CPU 12, a RAM 13, a ROM 14, and a hard disk drive (HDD) 15. The NW I/F 11, the CPU 12, the RAM 13, the ROM 14, and the HDD 15 are connected one another by a bus 16.

The NW I/F 11 can be connected to a network such as the Internet. The NW I/F 11 interchanges various types of information with the on-board device 20, the servers 40 of the non-life insurance companies A and B, and the server 30 of the company 3 via the network under the control of the CPU 12.

More specifically, the NW I/F 11 receives input of the duty information 31 that indicates the duty status of the main user 90 of the vehicle 2 from the server 30.

The NW I/F 11 receives input of use information about the use situation of the vehicle 2 from the on-board device 20. In the first embodiment, the use information indicates whether the engine of the vehicle 2 operates. For example, when the engine of the vehicle 2 starts, a use start notification is transmitted from the on-board device 20 as the use information.

When the input use information indicates that the vehicle 2 is in use, the NW I/F 11 outputs information indicating the car insurance applied to the vehicle 2 to the server 40 of the non-life insurance company A, B in accordance with the duty status of the main user 90. The NW I/F 11 outputs the car insurance selected by the CPU 12 from first car insurance and second car insurance, which are described later.

The NW I/F 11 is an example of the input circuit and the first input circuit. The NW I/F 11 is also an example of the output circuit and the first output circuit. The insurance switching device 10 in the first embodiment employs a structure in which the NW I/F 11 serves as both the input circuit and the output circuit. The NW I/F 11 may have a structure in which the input circuit and the output circuit are included as different interfaces.

The HDD 15 stores therein insurance switching information and the duty information 31. The HDD 15 is an example of the storage device of the insurance switching device 10. The insurance switching device 10 may include another storage device instead of or in addition to the HDD 15.

The CPU 12 executes a program stored in the ROM 14 or the HDD 15 to perform various types of processing. The CPU 12 is an example of the processor.

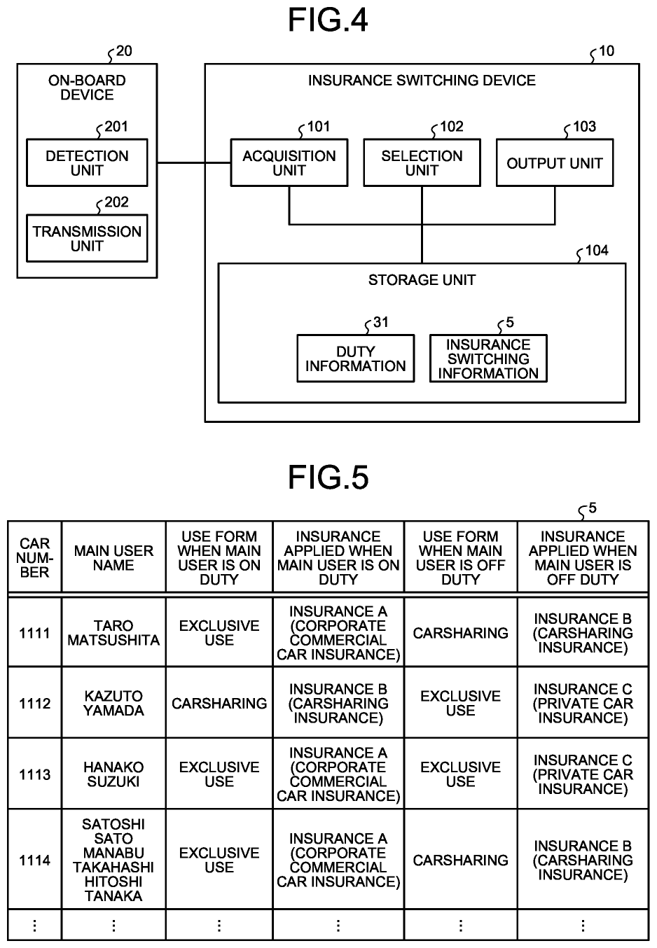

FIG. 4 is a diagram illustrating an example of functions of the insurance switching device 10 and the on-board device 20 according to the first embodiment. The program executed by the insurance switching device 10 in the first embodiment has a module structure including an acquisition unit 101, a selection unit 102, and an output unit 103 illustrated in FIG. 4. In the actual hardware operation, the CPU 12 reads out the program from the storage device such as the ROM 14 or the HDD 15 to execute the program, resulting in the respective units being loaded on a main storage device such as the RAM 13. As a result, the acquisition unit 101, the selection unit 102, and the output unit 103 are generated on the main storage device.

The acquisition unit 101 acquires the duty information 31 indicating the duty status of the main user 90 of the vehicle 2 from the server 30 via the NW I/F 11. The acquisition unit 101 stores the input duty information 31 in a storage unit 104.

The acquisition unit 101 receives the input of the use information about the use situation of the vehicle 2 from the on-board device 20 via the NW I/F 11.

The storage unit 104 illustrated in FIG. 4 is achieved by the HDD 15. The storage unit 104 stores therein insurance switching information 5 and the duty information 31.

FIG. 5 is a diagram illustrating an example of the insurance switching information 5 according to the first embodiment. In the duty information 31, the identification information about the vehicle 2, the identification information about the main user 90, the duty status of the main user 90, and the car insurance according to the duty status of the main user 90 are associated with one another.

More specifically, in the first embodiment, as illustrated in FIG. 5, in the insurance switching information 5, a car number, a main user name, a use form when the main user 90 is on duty, the insurance applied when the main user 90 is on duty, a use form when the main user 90 is off duty, and the insurance applied when the main user 90 is off duty are associated with one another. The car number is an example of the identification information about the vehicle 2. The main user name is an example of the identification information of the main user 90. The use form when the main user 90 is on duty is an example of the first use form. The use form when the main user 90 is off duty is an example of the second use form.

In FIG. 5, the duty statuses of the main user 90 and the pieces of car insurance according to the duty statuses of the main user 90 are illustrated in a single row in association with one another. A data structure may be employed in which the pieces of car insurance according to the duty statuses of the main user 90 are separated in different rows for each of the status of “on duty” and the status of “off duty”.

In the example illustrated in FIG. 5, the use form in which the main user 90 exclusively uses the vehicle 2 having a car number of “1111” is the first use form. When the duty status of “Taro Matsushita”, who is the main user 90 of the vehicle 2 having a car number of “1111” is “on duty”, the vehicle 2 having a car number of “1111” is exclusively used by the main user 90. In this case, the “insurance A”, which is applicable when “Taro Matsushita”, who is the main user 90, is on duty, is applied to the vehicle 2 having a car number of “1111”. The insurance A is corporate commercial car insurance.

The use form in which the vehicle 2 having a car number of “1111” is used with carsharing is the second use form. When the duty status of “Taro Matsushita”, who is the main user 90 of the vehicle 2 having a car number of “1111” is “off duty”, the vehicle 2 having a car number of “1111” can be used with carsharing. In this case, the “insurance B”, which is applicable when “Taro Matsushita”, who is the main user 90, is off duty, is applied to the vehicle 2 having a car number of “1111”. The insurance B is carsharing insurance.

The insurance applied when the main user 90 is on duty is an example of the first car insurance. The insurance applied when the main user 90 is off duty is an example of the second car insurance. In the first row in the insurance switching information 5 illustrated in FIG. 5, the insurance A is an example of the first car insurance while the insurance B is an example of the second car insurance.

The combination of the first car insurance and the second car insurance is not limited to the example described above. The first use form is not limited to the use form in which the vehicle 2 is exclusively used by the main user 90. The second use form is not limited to the use form in which the vehicle 2 is used with carsharing. For example, the use form in which the vehicle 2 is used with carsharing may be the first use form while the use form in which the vehicle 2 is exclusively used by the main user 90 may be the second use form.

In the example illustrated in FIG. 5, the vehicle 2 having a car number of “1112” is the private car owned by “Kazuto Yamada”, who is the main user 90, and is rented out as the carsharing vehicle when the main user 90 is on duty. In this case, when the main user 90 is on duty, the “insurance B”, which is the carsharing insurance, is applied to the vehicle 2. When the main user 90 is off duty, “insurance C”, which is private car insurance, is applied to the vehicle 2. In this case, the insurance B is an example of the first car insurance while the insurance C is an example of the second car insurance.

As a case of the vehicle 2 having a car number of “1113” illustrated in FIG. 5, the main user 90 may exclusively use the vehicle 2 both when the main user 90 is on duty and when the main user 90 is off duty. For an example of such case, the main user 90 uses the vehicle 2 as the commercial car of the company 3 when the main user 90 is on duty while the main user 90 uses the vehicle 2 as the private car when the main user 90 is off duty. In this case, the “insurance A”, which is the corporate commercial car insurance, is applied when the main user 90 is on duty. When the main user 90 is off duty, the “insurance C”, which is the private car insurance, is applied to the vehicle 2. In this case, the insurance A is an example of the first car insurance while the insurance C is an example of the second car insurance.

The number of main users 90 of the vehicle 2 is not limited to one. As a case of the vehicle 2 having a car number of “1114” illustrated in FIG. 5, a plurality of main users 90 may be associated with the single vehicle 2. In this case, the main user 90 is on duty in a case where at least one of the main users 90 is on duty.

FIG. 5 exemplarily illustrates one type of insurance for each of the corporate commercial car insurance, the carsharing insurance, and the private car insurance. A plurality of pieces of insurance may be registered which have different insurance covering items although they are applied to the same use.

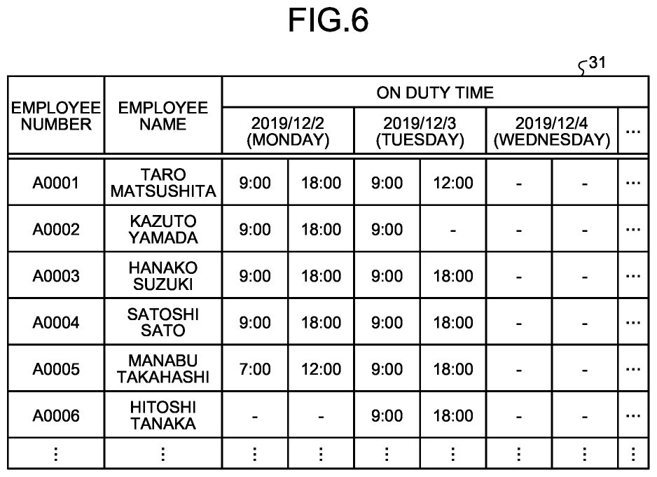

FIG. 6 is a diagram illustrating an example of the duty information 31 according to the first embodiment. As illustrated in FIG. 6, the HDD 15 may store information about the duty statuses of a plurality of employees acquired by the NW I/F 11 from the server 30 as a single database. FIG. 6 exemplarily illustrates the information about the duty statuses of the employees working for the single company 3. The HDD 15 may store therein the duty information 31 acquired by the NW I/F 11 from a plurality of different companies 3. In this case, the database may differ for each of the companies 3 or the information about the duty statuses of the employees of the multiple companies 3 may be stored in a single database.

In the example illustrated in FIG. 6, the duty information 31 is attendance management information in which an employee number, an employee name, a duty start time of the employee, and a duty end time of the employee are associated with one another. The duty start time and the duty end time are information that is input by respective employees from personal computers (PCs) provided in the company 3, for example. The employee number and the employee name are examples of the identification information about the main user 90 of the vehicle 2. The way in which the main user 90 inputs the duty start time and the duty end time is not limited to any specific way. For example, the main user 90 may input the duty start time and the duty end time from a smartphone or a mobile PC, which can be easily carried, for example. The duty information 31 may simply indicate a state of either on duty or off duty without time information.

Referring back to FIG. 4, the acquisition unit 101 periodically receives input of the latest duty information 31 from the server 30 via the NW I/F 11 to update the duty information 31 stored in the HDD 15. The duty information 31 changes in accordance with the actual duty status of the employee. The duty information 31 may be updated in such a manner that the part corresponding to the employee who is the main user 90 of the vehicle 2 that starts of being used is updated or the whole parts may be periodically updated. When the duty information 31 is changed on the server 30 side, the duty information 31 corresponding to the changed part may be transmitted to the insurance switching device 10 from the server 30.

For example, FIG. 6 illustrates the latest duty information 31 at the current time which is “19:00” on “Dec. 3, 2019”. The employee who had ended duty as of the current time is associated with the duty end time on “Dec. 3, 2019”.

In the first embodiment, the duty information 31 indicates the duty status of the employee with the duty start time and the duty end time that are actually registered by the employee. The contents of the duty information 31 are not limited to the example. For example, the duty information 31 may indicate the duty start time and the duty end time that are preliminarily determined by an employment rule, for example.

The selection unit 102 selects the car insurance applied to the vehicle 2 in accordance with the duty status of the main user 90. The car insurance applied to the vehicle 2 is the car insurance associated with the duty status indicated by the duty information 31 input into the NW I/F 11 in the insurance switching information 5.

More specifically, when the duty information 31 input into the NW I/F 11 indicates that the main user 90 is on duty, the selection unit 102 selects the first car insurance registered in the insurance switching information 5. When the duty information 31 input into the NW I/F 11 indicates that the main user 90 is off duty, the selection unit 102 selects the second car insurance registered in the insurance switching information 5.

For example, the current time of the duty information 31 illustrated in FIG. 6 is at “19:00” on “Dec. 3, 2019”. In this case, the selection unit 102 selects, at the current time, the insurance applied when the main user 90 is off duty for the vehicle 2 the main user 90 of which is the employee who is associated with the duty end time on “Dec. 3, 2019”.

The selection unit 102 selects, at the current time, the insurance applied when the main user 90 is on duty for the vehicle 2 the main user 90 of which is the employee who is not associated with the duty end time on “Dec. 3, 2019”. A concrete example is as follows. The selection unit 102 selects the “insurance A”, which is applied when the main user 90 is on duty, for the vehicle 2 that has a car number of “1111” and the main user 90 of which has the employee name “Matsushita Taro” in the time period from “9:00 to 12:00” on “Dec. 3, 2019”. When the vehicle 2 having a car number of “1111” is used from a time after “12:00” on “Dec. 3, 2019” to a time when “Matsushita Taro” starts duty again, the selection unit 102 selects the “insurance B”, which is applied when the main user 90 is off duty.

Another concrete example is as follows. At the current time, the duty end time is not associated with the employee name “Kazuto Yamada”, that is, “Kazuto Yamada” is on duty. The selection unit 102 selects the “insurance B”, which is applied when the main user 90 is on duty for the vehicle 2 that has a car number of “1112” and the main user 90 of which is “Kazuto Yamada”. The selection unit 102 sends out the selected car insurance to the output unit 103 in association with the car number of the vehicle 2.

The output unit 103 outputs the car insurance selected by the selection unit 102 to the server 40 of the non-life insurance company A, B via the NW I/F 11. For example, when the use information about the vehicle 2 input into the NW I/F 11 indicates that the vehicle 2 is in use, the output unit 103 outputs the information indicating the car insurance applied to the vehicle 2.

More specifically, when the duty information 31 defines that the main user 90 of the vehicle 2 mounted with the on-board device 20 is on duty at the time at which the use information is input into the NW I/F 11 from the on-board device 20, the output unit 103 outputs, from the NW I/F 11, the first car insurance registered in the insurance switching information 5 as the car insurance applied to the vehicle 2.

When the duty information 31 defines that the main user 90 of the vehicle 2 mounted with the on-board device 20 is off duty at the time at which the use information is input into the NW I/F 11 from the on-board device 20, the output unit 103 outputs, from the NW I/F 11, the second car insurance registered in the insurance switching information 5 as the car insurance applied to the vehicle 2.

The following describes functions of the on-board device 20. The program executed by the on-board device 20 in the first embodiment has a module structure including a detection unit 201 and a transmission unit 202 that are illustrated in FIG. 4. In the actual hardware operation, the CPU 22 reads out the program from the storage device such as the ROM 24 or the flash memory 25 to execute the program, resulting in the respective units being loaded on the main storage device such as the RAM 23. As a result, the detection unit 201 and the transmission unit 202 are generated on the main storage device. The on-board device 20 may further have other functions.

The detection unit 201 detects whether the engine of the vehicle 2 starts. For example, when an ignition power source of the vehicle 2 turns on, the detection unit 201 detects that the engine of the vehicle 2 starts.

When the power source of the on-board device 20 is an accessory power source or a regular power source that continues to supply power after the engine of the vehicle 2 stops, for example, the detection unit 201 detects that the engine of the vehicle 2 has stopped.

When the engine of the vehicle 2 starts, the transmission unit 202 transmits the use start notification to the insurance switching device 10 via the NW I/F 21 as the use information. The use start notification includes the car number of the vehicle 2 and information indicating the start time of the engine of the vehicle 2, for example.

During the operation of the engine of the vehicle 2, the transmission unit 202 periodically transmits a use notification indicating that the vehicle 2 is in use to the insurance switching device 10 via the NW I/F 21 as the use information. The transmission interval of the use notification is 10 minutes, for example. The transmission interval is not limited to the example. The use notification includes the car number of the vehicle 2 and information indicating the current time, for example.

In a case where the power source of the on-board device 20 is an accessory power source or a regular power source that continues to supply power after the engine of the vehicle 2 stops, for example, the transmission unit 202 transmits, to the insurance switching device 10 via the NW I/F 21, a use end notification indicating that the use of the vehicle 2 ends when the engine of the vehicle 2 has stopped. The use end notification includes the car number of the vehicle 2 and information indicating the time at which the engine of the vehicle 2 has stopped, for example.

In a case where the power source of the on-board device 20 is the ignition power source that stops supply of power when the engine of the vehicle 2 stops, the output unit 103 of the insurance switching device 10 may periodically request the use information to the on-board device 20 via the NW I/F 11. When no use information is transmitted from the on-board device 20 against the request, it may be determined that the use of the vehicle 2 has ended.

The following describes a flow of insurance switching processing executed by the insurance switching system S thus structured.

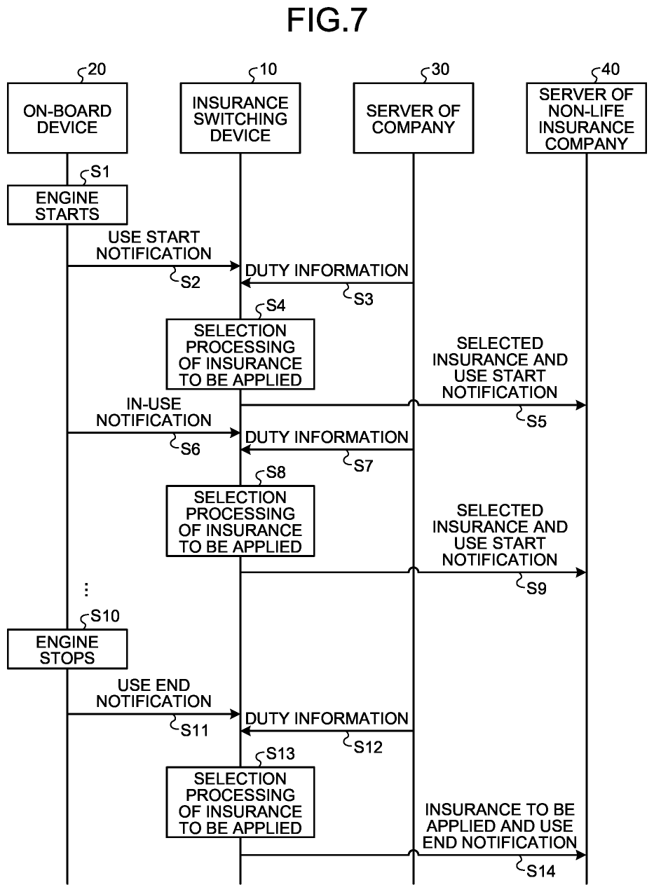

FIG. 7 is a sequence diagram illustrating an example of the flow of the insurance switching processing according to the first embodiment.

The detection unit 201 of the on-board device 20 detects that the engine of the vehicle 2 has started (S1). Under the control of the transmission unit 202 of the on-board device 20, the NW I/F 21 outputs the use start notification of the vehicle 2 mounted with the on-board device 20 to the insurance switching device 10 (S2). In this case, the NW I/F 11 of the insurance switching device 10 receives the input of the use start notification of the vehicle 2 mounted with the on-board device 20.

Under the control of the acquisition unit 101 of the insurance switching device 10, the NW I/F 11 receives, from the server 30 of the company 3, input of the duty information 31 indicating the duty status of the main user 90 of the vehicle 2 (S3). For example, the acquisition unit 101 searches for the main user name associated with the car number included in the use start notification sent by the processing at S2 from the insurance switching information 5, and requests the duty information 31 associated with the main user name to the server 30. Alternatively, the acquisition unit 101 may request the duty information 31 about all main users 90 to the server 30. The acquisition unit 101 stores the acquired duty information 31 in the HDD 15.

The selection unit 102 of the insurance switching device 10 performs selection processing of the insurance applied to the vehicle 2 (S4).

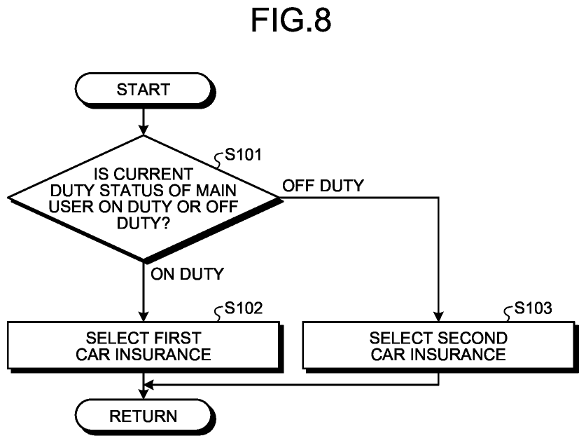

FIG. 8 is a flowchart illustrating an example of a flow of the selection processing of the insurance according to the first embodiment.

The selection unit 102 determines, from the latest duty information 31 stored in the HDD 15, whether the current duty status of the main user 90 associated with the car number included in the use start notification sent by the processing at S2 is on duty or off duty (S101).

If it is determined that the main user 90 associated with the car number is on duty (“on duty” at S101), the selection unit 102 selects the insurance applied when the main user 90 associated with the car number is on duty, that is, the first car insurance, from the insurance switching information 5 (S102).

If it is determined that the main user 90 associated with the car number is off duty (“off duty” at S101), the selection unit 102 selects the insurance applied when the main user 90 associated with the car number is off duty, that is, the second car insurance, from the insurance switching information 5 (S103). The description now refers back to the sequence diagram in FIG. 7.

Under the control of the output unit 103 of the insurance switching device 10, the NW I/F 11 outputs the insurance selected by the selection unit 102 and the use start notification of the vehicle 2 in association with each other to the server 40 of the non-life insurance company A, B (S5). The insurance switching device 10 transmits the selected insurance and the use start notification of the vehicle 2 to only the server 40 of the non-life insurance company that provides the insurance selected by the selection unit 102 from the non-life insurance companies A and B.

The insurance switching device 10 outputs the selected insurance and the use start notification of the vehicle 2 to the server 40 as described above. As a result, the non-life insurance company A, B can grasp that from when the vehicle 2 is being used while which insurance is being applied. If an accident involving the vehicle 2 occurs, it is easy to identify the insurance having been applied to the vehicle 2 at the accident occurrence time.

Under the control of the transmission unit 202 of the on-board device 20, the NW I/F 21 outputs an in-use notification to the insurance switching device 10 when a certain time, for example, 10 minutes, elapses from the transmission of the use start notification at S2 (S6).

Under the control of the acquisition unit 101 of the insurance switching device 10, the NW I/F 11 receives the input of the duty information 31 indicating the duty status of the main user 90 of the vehicle 2 from the server 30 of the company 3 in the same manner as the processing at S3 (S7).

The selection unit 102 of the insurance switching device 10 performs the selection processing of the insurance applied to the vehicle 2 in the same manner as the processing at S4 (S8).

Under the control of the output unit 103 of the insurance switching device 10, the NW I/F 11 outputs the insurance selected by the selection unit 102 and the use start notification of the vehicle 2 in association with each other to the server 40 of the non-life insurance company A, B in the same manner as the processing at S5 (S9).

During a time period when the vehicle 2 is used, the on-board device 20 and the insurance switching device 10 repeat the processing from S6 to S8.

In FIG. 7, the on-board device 20 transmits the in-use notification on the basis of the determination on a lapse of a certain time. The insurance switching device 10 may transmit an in-use notification request to the on-board device 20 from the NW I/F 11 at certain time intervals. In this case, when receiving the in-use notification request from the insurance switching device 10, the on-board device 20 transmits the in-use notification to the insurance switching device 10.

The detection unit 201 of the on-board device 20 detects that the engine of the vehicle 2 has stopped (S10). In this case, under the control of the transmission unit 202 of the on-board device 20, the NW I/F 21 outputs the use end notification of the vehicle 2 mounted with the on-board device 20 to the insurance switching device 10 (S11).

Under the control of the acquisition unit 101 of the insurance switching device 10, the NW I/F 11 receives the input of the duty information 31 indicating the duty status of the main user 90 of the vehicle 2 from the server 30 of the company 3 in the same manner as the processing at S3 and S6 (S12).

The selection unit 102 of the insurance switching device 10 performs the selection processing of the insurance applied to the vehicle 2 in the same manner as the processing at S4 and S7 (S13).

Under the control of the output unit 103 of the insurance switching device 10, the NW I/F 11 outputs the insurance selected by the selection unit 102 and the use start notification of the vehicle 2 to the server 40 of the non-life insurance company A, B in association with each other in the same manner as the processing at S5 and S9 (S14). The processing in the sequence diagram ends.

The processing in the sequence diagram is repeatedly performed every time when the engine of the vehicle 2 starts again. For example, in a case where the duty status of the main user 90 has changed when the engine of the vehicle 2 starts the next time, the insurance switching device 10 performs the selection processing of the insurance on the basis of the duty status after the change.

As described above, the control method of the insurance switching device 10 in the first embodiment includes the step at which the NW I/F 11 receives the input of the duty information 31 indicating the duty status of the main user 90 of the vehicle 2, the step at which the NW I/F 11 receives the input of the use information about the use situation of the vehicle 2, and the step at which the NW I/F 11 outputs the information indicating the car insurance applied to the vehicle 2 in accordance with the duty status of the main user 90 when the use information input into the NW I/F 11 indicates that the vehicle 2 is in use. The control method of the insurance switching device 10 in the first embodiment enables automatic switching of the car insurance applied to the vehicle 2 in accordance with the duty status of the main user 90.

The automatic switching of the car insurance applied to the vehicle 2 can reduce omission in switching of the car insurance due to manual operation and wrong selection.

The insurance switching device 10 in the first embodiment includes the HDD 15 that stores therein the insurance switching information 5. The car insurance applied to the vehicle 2 is the car insurance associated with the duty status indicated by the duty information 31 input into the NW I/F 11 in the insurance switching information 5. The control method of the insurance switching device 10 in the first embodiment can easily identify the car insurance according to the duty status of the main user 90.

The control method of the insurance switching device 10 in the first embodiment includes the step at which the first car insurance registered in the insurance switching information 5 is output as the car insurance applied to the vehicle 2 when the duty information 31 defines that the main user 90 is on duty at the time at which the use information is input, and the step at which the second car insurance registered in the insurance switching information 5 is output as the car insurance applied to the vehicle 2 when the duty information 31 defines that the main user 90 is off duty at the time at which the use information is input. The control method of the insurance switching device 10 in the first embodiment can apply the insurance according to the duty status of the main user 90 from a plurality of different pieces of car insurance.

In the first embodiment, in the insurance switching information 5, the first use form of the vehicle 2 when the main user 90 is on duty and the second use form of the vehicle 2 when the main user 90 is off duty are associated with each other. The control method of the insurance switching device 10 in the first embodiment can automatically apply the car insurance suitable for each use form when the vehicle 2 is used in a plurality of different use forms. Thus, it becomes easier to operate the vehicle 2 that is used as the commercial car during the daytime on weekdays as a carsharing vehicle at night or weekends, when the vehicle 2 is not used for business.

### Second Embodiment

In a second embodiment, the insurance switching device outputs an alert when the vehicle 2 is used in a use form different from that determined to be the use form when the main user 90 is on duty.

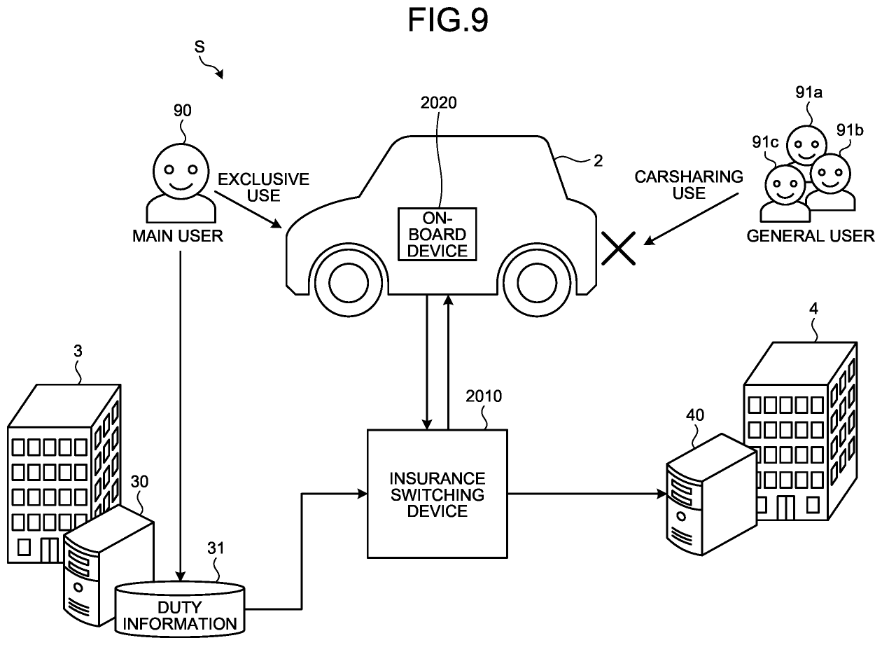

FIG. 9 is a diagram illustrating an example of the whole structure of the insurance switching system S according to the second embodiment. As illustrated in FIG. 9, the insurance switching system S in the second embodiment includes an insurance switching device 2010 and an on-board device 2020.

In the example illustrated in FIG. 9, when the duty status of the main user 90 is associated with the use form in which the main user 90 exclusively uses the vehicle 2 as a commercial car, and the general user 91 uses the vehicle 2 with carsharing, the insurance switching device 2010 outputs the alert to the on-board device 2020. When the insurance switching device 2010 outputs the alert, the on-board device 2020 outputs the alert to notify the general user 91 of the use form being incorrect.

The insurance switching device 2010 and the on-board device 2020 each have the same hardware structure as that in the first embodiment.

The on-board device 2020 includes the NW I/F 21, the CPU 22, the RAM 23, the ROM 24, the flash memory 25, the device I/F 26, and the display 27 in the same manner as the first embodiment. The device I/F 26 connects the display 27 and the IC card reader 28.

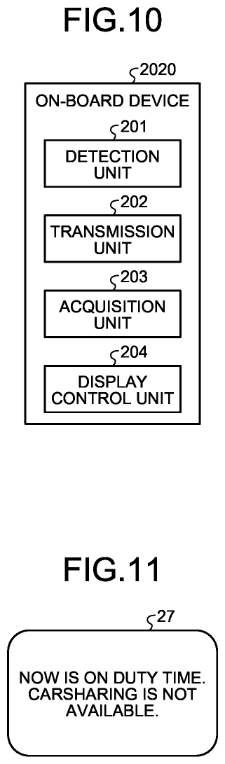

FIG. 10 is a diagram illustrating an example of functions of the on-board device 2020 according to the second embodiment. The CPU 22 reads out a program from the storage device such as the ROM 24 or the flash memory 25 to execute the program. As a result, the detection unit 201, the transmission unit 202, an acquisition unit 203, and a display control unit 204 illustrated in FIG. 10 are loaded on the main storage device such as the RAM 23, resulting in the detection unit 201, the transmission unit 202, the acquisition unit 203, and the display control unit 204 being generated on the main storage device.

The NW I/F 21 receives input of the alert from the insurance switching device 2010 under the control of the acquisition unit 203 in addition to the function in the first embodiment. In the second embodiment, the alert indicates that a combination of the use form of the vehicle 2 and the duty status of the main user 90 of the vehicle 2 does not coincide with the combination of the use form and the duty status defined in the insurance switching information 5.

The device I/F 26 acquires information indicating the use form of the vehicle 2 from the IC card reader 28 under the control of the acquisition unit 203 in addition to the function in the first embodiment. More specifically, the acquisition unit 203 acquires that the use form of the vehicle 2 is carsharing via the device I/F 26 when the IC card reader 28 reads the IC card held by the general user 91 for using the vehicle 2 with carsharing. When the IC card reader 28 reads no IC card or the engine of the vehicle 2 starts, the acquisition unit 203 determines that the use form of the vehicle 2 is the exclusive use by the main user.

When the NW I/F 21 receives the input of the alert from the insurance switching device 2010, the device I/F 26 outputs the alert to the display 27 under the control of the display control unit 204.

FIG. 11 is a diagram illustrating an example of the alert displayed on the display 27 according to the second embodiment. The alert illustrated in FIG. 11 “Now is on duty time. Carsharing is not available” is displayed when the general user 91 holds the IC card so as to use carsharing although the use form of the main user 90 who is on duty is registered as “exclusively use” in the insurance switching information 5. This alert is also displayed when the main user 90 on duty holds the IC card so as to use the vehicle 2 not in regular use but with carsharing. FIG. 11 illustrates an example in which the alert is displayed as a text message. The alert may be displayed by a chart or an image.

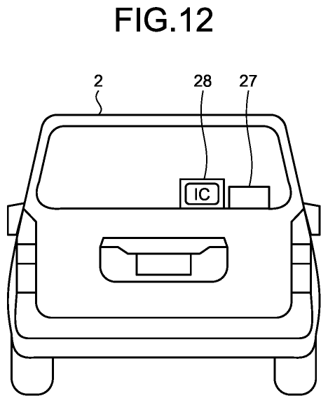

FIG. 12 is a diagram illustrating an example of an installation position of the display 27 according to the second embodiment. As illustrated in FIG. 12, the display 27 is installed near the IC card reader 28 provided on the rear side of the vehicle 2, as an example. The positions of the IC card reader 28 and the display 27 are not limited to those in the example.

The insurance switching device 2010 includes the NW I/F 11, the CPU 12, the RAM 13, the ROM 14, and the HDD 15 in the same manner as the first embodiment. The insurance switching device 2010 in the second embodiment includes the functions of the acquisition unit 101, the selection unit 102, the output unit 103, and the storage unit 104 in the same manner as the first embodiment.

The NW I/F 11 receives input of the use form of the vehicle 2 from the on-board device 2020 under the control of the acquisition unit 101 in addition to the functions described in the first embodiment.

The NW I/F 11 outputs an alert to the on-board device 2020 under the control of the output unit 103 when a combination of the use form input from the on-board device 2020 and the duty status of the main user 90 at the time at which the use form is input does not coincide with the combination of the use form and the duty status defined in the insurance switching information 5.

In the second embodiment, the expression “outputs the alert” is used both when the insurance switching device 2010 outputs an alert signal to the on-board device 2020 via the network and when the on-board device 2020 outputs an alert message or an alert image to the display 27. The NW I/F 11 of the insurance switching device 2010 may not only output the alert signal to the on-board device 2020 via the network but also output notification of possibility of an incorrect use form to the servers 40 of the non-life insurance companies A and B or the server 30 of the company 3, for example.

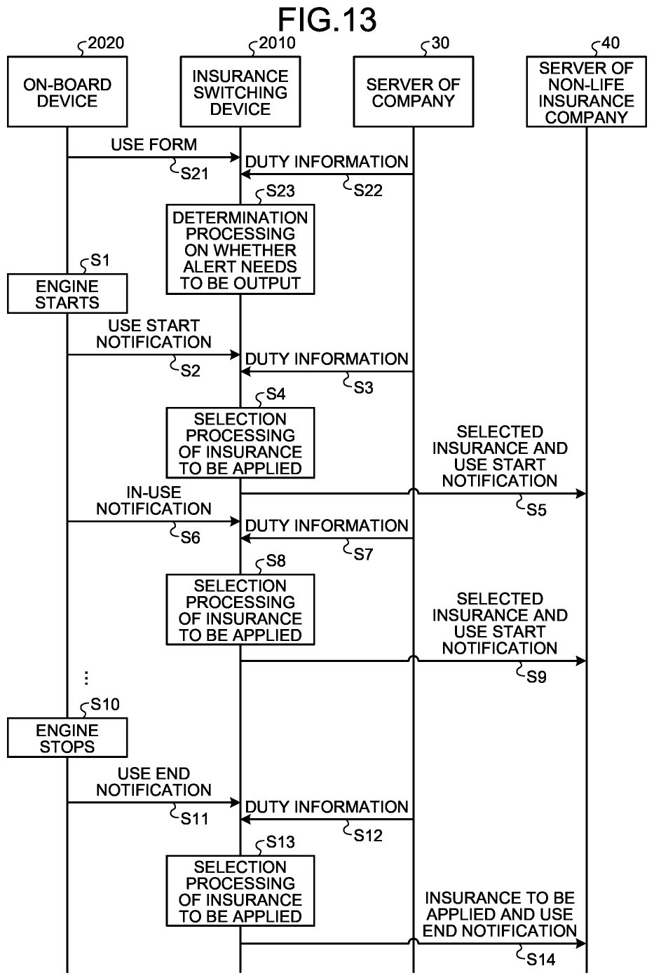

FIG. 13 is a sequence diagram illustrating an example of a flow of the insurance switching processing according to the second embodiment.

As illustrated in FIG. 13, the on-board device 2020 outputs the current use form of the vehicle 2 to the insurance switching device 2010 (S21). In this case, the NW I/F 11 of the insurance switching device 2010 receives the input of the use form.

Under the control of the acquisition unit 101 of the insurance switching device 2010, the NW I/F 11 receives the input of the duty information 31 indicating the duty status of the main user 90 of the vehicle 2 from the server 30 of the company 3 (S22). The acquisition unit 101 stores the acquired duty information 31 in the HDD 15.

The output unit 103 of the insurance switching device 2010 performs determination processing on whether the alert needs to be output (S23).

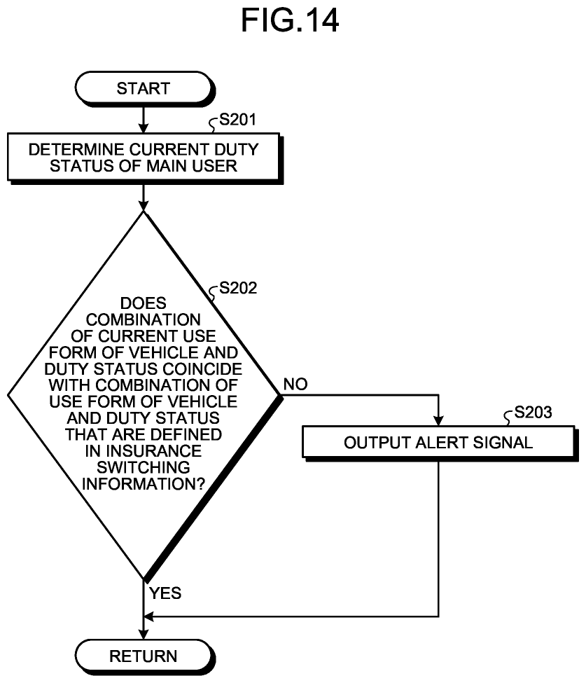

FIG. 14 is a flowchart illustrating an example of a flow of the determination processing whether the alert needs to be output according to the second embodiment.

The output unit 103 determines whether the current duty status of the main user 90 is on duty or off duty from the latest duty information 31 stored in the HDD 15 (S201).

The output unit 103 determines whether a combination of the current use form of the vehicle 2 input from the on-board device 2020 and the current duty status of the main user 90 determined at S201 coincides with the combination of the use form of the vehicle 2 and the duty status defined in the insurance switching information 5.

For example, in the example of the insurance switching information 5 illustrated in FIG. 5, the combination of the duty status “on duty” of the main user 90 and the use form “exclusively use”, and the combination of the duty status “off duty” of the main user 90 and the use form “carsharing” are defined for the vehicle 2 having a car number of “1111”. If either one of the two combinations coincides with the combination of the current use form of the vehicle 2 input from the on-board device 2020 and the current duty status of the main user 90 determined at S201, the output unit 103 determines that the combination of the current use form of the vehicle 2 input from the on-board device 2020 and the current duty status of the main user 90 determined at S201 coincides with the combination of the use form of the vehicle 2 and the duty status defined in the insurance switching information 5.

If the output unit 103 determines the combinations coincide with each other (“Yes” at S202), the NW I/F 11 outputs no alert and the processing returns to the processing in the sequence diagram in FIG. 13.

If the combination of the current use form of the vehicle 2 input from the on-board device 2020 and the current duty status of the main user 90 determined at S201 does not coincide with any of the combinations associated with the car number of the vehicle 2 mounted with the on-board device 2020 in the insurance switching information 5 (“No” at S202), the NW I/F 11 outputs the alert signal to the on-board device 2020 under the control of the output unit 103 (S203).

In this case, the NW I/F 21 of the on-board device 2020 receives the input of the alert signal from the insurance switching device 2010. The device I/F 26 of the on-board device 2020 outputs the alert to the display 27 under the control of the display control unit 204. The processing of the flowchart ends. The processing returns to the processing in the sequence diagram in FIG. 13. The processing followed by the processing at S1 in the sequence diagram in FIG. 13 is the same as that in the first embodiment.

The insurance switching device 2010 may perform the determination processing whether the alert needs to be output not only at the use start time of the vehicle 2 but also during the running of the vehicle 2 periodically, for example, every 10 minutes.

For example, in a case where the main user 90 starts duty when the general user 91 is using the vehicle 2 with carsharing, at that time, the combination of the use form of the vehicle 2 and the current duty status of the main user 90 does not coincide with the combination of the use form of the vehicle 2 and the duty status defined in the insurance switching information 5. In this case, the NW I/F 11 of the insurance switching device 2010 outputs the alert signal to the on-board device 2020 under the control of the output unit 103. The device I/F 26 of the on-board device 2020 outputs the alert to the display 27 under the control of the display control unit 204. In a case where the alert is output when the vehicle 2 is in use, the device I/F 26 causes the display 27 provided at the center of the instrument panel (not illustrated) of the vehicle 2 to display the alert.

When receiving the input of the alert signal from the insurance switching device 2010 at the use start time of the vehicle 2, the on-board device 2020 may further perform control such as locking that causes the engine of the vehicle 2 not to start.

The control method of the insurance switching device 2010 in the second embodiment outputs the alert when a combination of the use form of the vehicle 2 input into the NW I/F 11 and the duty status of the main user 90 at the time at which the use form is input does not coincide with the combination of the use form and the duty status defined in the insurance switching information 5. The control method of the insurance switching device 2010 in the second embodiment can inform the main user 90 or the general user 91 who uses the vehicle 2 that the use form is incorrect when the vehicle 2 is used based on the combination different from the predetermined combination of the duty status of the main user 90 and the use form, thereby making it possible to reduce the use of the vehicle 2 with the wrong use form in addition to having the effects of the first embodiment.

The reduction in use of the vehicle 2 with the wrong use form can reduce a discrepancy between the car insurance applied to the vehicle 2 and the actual use form.

### Third Embodiment

In a third embodiment, the insurance switching device outputs the alert when the use situation of the vehicle 2 violates terms of use.

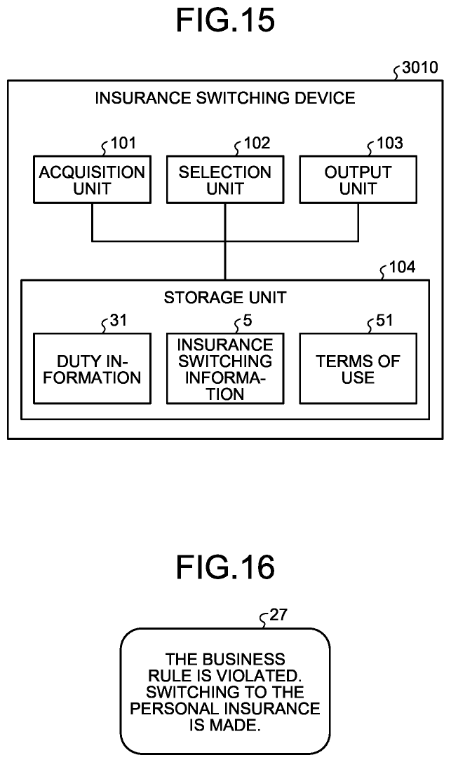

FIG. 15 is a diagram illustrating an example of functions of an insurance switching device 3010 according to the third embodiment.

The insurance switching device 3010 in the third embodiment has the same hardware structure as those of the first embodiment and the second embodiment. As illustrated in FIG. 15, the storage unit 104 of the insurance switching device 3010 in the third embodiment, that is, the HDD 15 stores therein the duty information 31, the insurance switching information 5, and terms of use 51. The duty information 31 and the insurance switching information 5 are the same as those in the first embodiment and the second embodiment.

The terms of use 51 define a region in which the vehicle 2 can run when the vehicle 2 is exclusively used by the main user 90 on duty. When the vehicle 2 is used with carsharing, the terms of use 51 are not applied. In a case where the vehicle 2 is exclusively used by the main user 90 when the main user 90 is off duty, such as the case of the car number “1113” described with reference to FIG. 5, the terms of use 51 may also not be applied.

More specifically, the case where the vehicle 2 is exclusively used by the main user 90 is a case where the vehicle 2 is used as the commercial car, for example. In this case, the terms of use 51 define a region in which the vehicle 2 can run when the main user 90 uses the vehicle 2 for business as the commercial car. When the main user 90 runs the vehicle 2 beyond the region, there is a possibility that the main user 90 uses the vehicle 2 for a private purpose.

The terms of use 51 are not limited to the terms described above. Examples of the terms of use 51 may include the upper limit of the number of speed limit violations and an upper limit speed.

The NW I/F 11 of the insurance switching device 3010 acquires running information about the vehicle 2 from the on-board device 2020 under the control of the acquisition unit 101 in addition to the functions described in the first embodiment or the second embodiment. The running information includes at least one of the position and the speed of the vehicle 2.

When the use situation of the vehicle 2 violates the terms of use 51, the NW I/F 11 of the insurance switching device 3010 outputs the alert to the on-board device 2020 under the control of the output unit 103 in addition to the functions described in the first embodiment or the second embodiment. For example, when the position of the vehicle 2 indicated by the running information about the vehicle 2 acquired from the on-board device 2020 is out of the region defined in the terms of use 51, the output unit 103 determines that the use situation of the vehicle 2 violates the terms of use 51 and outputs the alert to the on-board device 2020 by the NW I/F 11.

When the vehicle 2 is a commercial car, the main user 90 of the vehicle 2 is on duty, and the use situation of the vehicle 2 violates the terms of use 51, the selection unit 102 of the insurance switching device 3010 selects again the insurance applied to the vehicle 2 in such a manner to switch the first car insurance to other car insurance other than the first car insurance. For example, the car number “1111” registered in the insurance switching information 5 described with reference to FIG. 5 is associated with the insurance A, which is the corporate commercial car insurance, as the first car insurance. The car number “1111” is associated with the insurance B, which is the carsharing insurance, as the second car insurance. When the use situation of the vehicle 2 violates the terms of use 51, the selection unit 102 selects the insurance C, which is the private car insurance, for example.

The car insurance applied when the use situation of the vehicle 2 violates the terms of use 51 may be registered in the insurance switching information 5 in association with the car number, or may be defined in the terms of use 51.

When the use situation of the vehicle 2 violates the terms of use 51, the NW I/F 11 of the insurance switching device 3010 outputs the car insurance selected by the selection unit 102 to the server 40 of the non-life insurance company A, B under the control of the output unit 103.

The NW I/F 21 of the on-board device 2020 receives the input of the alert indicating violation of the terms of use 51 from the insurance switching device 2010 under the control of the acquisition unit 203 in addition to the functions described in the first embodiment or the second embodiment.

When the NW I/F 21 receives the input of the alert from the insurance switching device 2010, the device I/F 26 of the on-board device 2020 outputs the alert to the display 27 under the control of the display control unit 204.

FIG. 16 is a diagram illustrating an example of the alert displayed on the display 27 according to the third embodiment. FIG. 16 illustrates a text message “The business rule is violated. Switch to the personal insurance is made” as an example of the alert. The alert may be expressed by a chart or an image.

In the third embodiment, the expression “outputs the alert” is used both when the insurance switching device 3010 outputs an alert signal to the on-board device 2020 via the network and when the on-board device 2020 outputs an alert message or an alert image to the display 27. The NW I/F 11 of the insurance switching device 3010 may not only output the alert signal to the on-board device 2020 via the network but also output notification of possibility of an incorrect use form to the servers 40 of the non-life insurance companies A and B or the server 30 of the company 3.

In the third embodiment, the insurance switching device 3010 does not only output the alert but also reselect the insurance when the use situation of the vehicle 2 violates the terms of use 51. The insurance switching device 3010 may, however, only output the alert.

As described above, in the control method of the insurance switching device 3010 in the third embodiment, when the use situation of the vehicle 2 violates the terms of use 51, the NW I/F 11 outputs the alert. The control method of the insurance switching device 3010 in the third embodiment can reduce inappropriate uses of the vehicle 2 in addition to having the effects of the first embodiment or the second embodiment.

The terms of use 51 in the third embodiment defines a region in which the vehicle 2 can run in a case where the vehicle 2 is exclusively used by the main user 90 on duty. The control method of the insurance switching device 3010 in the third embodiment can reduce a case where the vehicle 2 is used privately when the main user 90 is on duty.

### Modification

A part or all of the functions described as the functions of the insurance switching devices 10, 2010, and 3010 in the first, the second, and the third embodiments may be achieved by the on-board device 20 or 2020. When such a structure is employed, the on-board device 20 or 2020 may be an example of the insurance switching device. The on-board device 20 or 2020 may be not only the ECU or the OBU, but also a mobile device such as a smartphone.

A part or all of the functions described as the functions of the insurance switching devices 10, 2010, and 3010 in the first, the second, and the third embodiments described above may be achieved by cooperative operation of the server and the on-board device. In this case, a combination of the server and the on-board device can be regarded as a single insurance switching device.

As described above, the first to the third embodiments enables automatic switching of the car insurance applied to the vehicle 2 in accordance with the duty status of the user.

The control method of an insurance switching device and an insurance switching system according to the disclosure enables automatic switching of the car insurance applied to the vehicle in accordance with the duty status of the user.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control method of an insurance switching device that includes an input circuit and an output circuit, the control method comprising:
receiving, by the input circuit, input of duty information indicating a duty status of a user of a vehicle;
receiving, by the input circuit, input of use information about a use situation of the vehicle; and
outputting, by the output circuit, information indicating car insurance applied to the vehicle when the use information input into the input circuit indicates that the vehicle is in use.

2. The control method of an insurance switching device according to claim 1, wherein
the insurance switching device further includes a storage device,
the storage device stores therein insurance switching information in which identification information about the vehicle, identification information about the user, the duty status of the user, and the car insurance according to the duty status of the user are associated with one another, and
a car insurance applied to the vehicle is the car insurance associated with the duty status indicated by the duty information input into the input circuit in the insurance switching information.

3. The control method of an insurance switching device according to claim 2, wherein
the duty status is on duty or off duty,
the identification information about the vehicle, the identification information about the user, first car insurance applied when the user is on duty, and second car insurance applied when the user is off duty are associated with one another in the insurance switching information,
the control method includes:
outputting, by the output circuit, the first car insurance registered in the insurance switching information as the car insurance applied to the vehicle when the duty information defines that the user is on duty at a time at which the use information is input into the input circuit; and
outputting, by the output circuit, the second car insurance registered in the insurance switching information as the car insurance applied to the vehicle when the duty information defines that the user is off duty at a time at which the use information is input into the input circuit.

4. The control method of an insurance switching device according to claim 3, wherein
the insurance switching device further includes a processor, and
the control method includes:
selecting, by the processor, the first car insurance registered in the insurance switching information when the duty information input into the input circuit indicates that the user is on duty;
selecting, by the processor, the second car insurance registered in the insurance switching information when the duty information input into the input circuit indicates that the user is off duty; and
outputting, by the output circuit, the car insurance selected by the processor from the first car insurance and the second car insurance.

5. The control method of an insurance switching device according to claim 3, wherein a first use form of the vehicle when the user is on duty and a second use form of the vehicle when the user is off duty are further associated in the insurance switching information.

6. The control method of an insurance switching device according to claim 5, wherein
the first use form is exclusive use of the vehicle by the user, and
the second use form is carsharing.

7. The control method of an insurance switching device according to claim 5, wherein
the first use form is carsharing, and
the second use form is exclusive use of the vehicle by the user.

8. The control method of an insurance switching device according to claim 5, further comprising:
receiving, by the input circuit, input of the use form of the vehicle; and
outputting, by the output circuit, an alert when a combination of the use form input into the input circuit and the duty status of the user at a time at which the use form is input into the input circuit does not coincide with a combination of the use form and the duty status that are defined in the insurance switching information.

9. The control method of an insurance switching device according to claim 2, wherein
the storage device further stores therein terms of use of the vehicle, and
the control method further includes outputting, by the output unit, an alert when the use situation of the vehicle violates the terms of use.

10. The control method of an insurance switching device according to claim 9, wherein the terms of use define a region in which the vehicle is capable of running when the vehicle is exclusively used by the user.

11. An insurance switching system comprising:
an on-board device that is capable of being mounted on a vehicle; and
an insurance switching device that is capable of communicating with the on-board device, wherein
the on-board device outputs use information about a use situation of the vehicle to the insurance switching device,
the insurance switching device includes:
a first input circuit; and
a first output circuit,
the first input circuit receives input of the use information about the use situation of the vehicle from the on-board device, and further receives input of duty information indicating a duty status of a user of the vehicle from a further information processing device, and
the first output circuit outputs information indicating car insurance applied to the vehicle in accordance with the duty status of the user when the use information input into the first input circuit indicates that the vehicle is in use.

12. The insurance switching system according to claim 11, wherein
the insurance switching device further includes a storage device,
the storage device stores therein insurance switching information in which identification information about the vehicle, identification information about the user, the duty status of the user, and the car insurance according to the duty status of the user are associated with one another, and
a car insurance applied to the vehicle is the car insurance associated with the duty status indicated by the duty information input into the first input circuit in the insurance switching information.

13. The insurance switching system according to claim 12, wherein
the duty status is on duty or off duty,
the identification information about the vehicle, the identification information about the user, first car insurance applied when the user is on duty, and second car insurance applied when the user is off duty are associated with one another in the insurance switching information,
the first output circuit outputs the first car insurance registered in the insurance switching information as the car insurance applied to the vehicle when the duty information defines that the user is on duty at a time at which the use information is input into the first input circuit, and outputs the second car insurance registered in the insurance switching information as the car insurance applied to the vehicle when the duty information defines that the user is off duty at a time at which the use information is input into the first input circuit.

14. The insurance switching system according to claim 13, wherein
the insurance switching device further includes a processor,
the processor selects the first car insurance registered in the insurance switching information when the duty information input into the first input circuit indicates that the user is on duty,
the processor selects the second car insurance registered in the insurance switching information when the duty information input into the first input circuit indicates that the user is off duty, and
the first output circuit outputs the car insurance selected by the processor from the first car insurance and the second car insurance.

15. The insurance switching system according to claim 13, wherein a first use form of the vehicle when the user is on duty and a second use form of the vehicle when the user is off duty are further associated in the insurance switching information.

16. The insurance switching system according to claim 15, wherein
the first use form is exclusive use of the vehicle by the user, and
the second use form is carsharing.

17. The insurance switching system according to claim 15, wherein
the first use form is carsharing, and
the second use form is exclusive use of the vehicle by the user.

18. The insurance switching system according to claim 15, wherein
the on-board device includes:
a display unit;
a second input circuit; and
a second output circuit,
the first input circuit further receives input of the use form of the vehicle from the on-board device when use of the vehicle starts,
the first output circuit outputs an alert to the on-board device when a combination of the use form input into the first input circuit and the duty status of the user at a time at which the use form is input into the first input circuit does not coincide with a combination of the use form and the duty status that are defined in the insurance switching information,
the second input circuit receives input of the alert from the insurance switching device, and
the second output circuit outputs the alert to the display unit.

19. The insurance switching system according to claim 12, wherein
the on-board device includes:
a display unit;
a second input circuit; and
a second output circuit,
the storage device further stores therein terms of use of the vehicle,
the first output circuit outputs an alert to the on-board device when the use situation of the vehicle violates the terms of use,
the second input circuit receives input of the alert from the insurance switching device, and
the second output circuit outputs the alert to the display unit.

20. The insurance switching system according to claim 19, wherein the terms of use define a region in which the vehicle is capable of running when the vehicle is exclusively used by the user.
